(19) United States
(12) Patent Application Publication
(10) Pub. No.: US 2010/0106534 A1
(43) Pub. Date: Apr. 29, 2010

(54) CERTIFICATION AND RISK-MANAGEMENT SYSTEM AND METHOD FOR A RENTAL AGREEMENT

(75) Inventors: Timothy L. Robinson, Reston, VA (US); Brad R. Childt, Boulder, CO (US); Duane S. Kobayashi, Reston, VA (US)

Correspondence Address: LAW OFFICE OF DUANE S. KOBAYASHI, P.O. Box 4160, Leesburg, VA, 20177, US

(73) Assignee: Solid People LLC, Boulder, CO (US)

(21) Appl. No.: 12/258,293

(22) Filed: Oct. 24, 2008

(51) Int. Cl. G06Q 10/00

(52) U.S. Cl. 705/5

(57) ABSTRACT

A certification and risk-management system and method for a rental agreement. The present invention provides a mechanism for determining that an individual who would normally be deemed a high-risk for a rental agreement (e.g., vehicle rental) is not a high-risk, guaranteeing such individual, and thereby enabling the individual to participate in the rental agreement more readily. By screening an individual via a multitude of criteria, a guarantee provider can certify to a rental agency that a customer is an acceptable risk for the rental agreement, and in the event the rental agency incurs a cost (e.g., related to the individual's use of a vehicle), the guarantee provider can guarantee that the rental agency will be reimbursed for the cost.

### TECHNICAL FIELD

This application relates generally to procedures for a rental agreement. More particularly, the present invention relates to a system and method for certifying a level of risk for an individual desiring to participate in a rental agreement and guaranteeing reimbursement to a rental agency for a cost incurred due to the individual's use of a vehicle.

### BACKGROUND

Generally, rental businesses desire to reduce the risk involved in renting goods to customers. A risk assessment of a customer is particularly important when the property to be rented has significant value, such as a vehicle. As such, a rental agency may employ strict guidelines when determining whether to rent to an individual. This may be especially true if the renter is potentially judgment proof. A rental agency's risk is significantly higher if the renter does not have the financial wherewithal to reimburse the rental agency for repairing or replacing the rented goods. Even if the rental agency secures a legal judgment against the renter, the renter's lack of finances may make the satisfaction of that judgment difficult or impossible. Vehicle rental agencies employ strict rules when renting to young drivers because young drivers are considered to be high risk due to a perceived lack of experience and lack of financial resources. Although a renter's automobile insurance may reimburse the rental agency for some costs, it may not provide total reimbursement. Many rental agencies refuse service to anyone under the age of 21. Some rental agencies allow an individual between the ages of 18 and 24 to rent, but only if the individual pays a surcharge. There are some exceptions to these policies, but young drivers are typically inconvenienced or excluded when attempting to rent vehicles.

Although such policies may protect rental agencies from losses by discouraging or preventing some high-risk drivers from renting vehicles, they also discourage potential customers. Even if one is given the option to pay a surcharge, he may choose to find alternative means of transportation rather than spend the extra money. Furthermore, using age as the sole risk criterion may cause a rental agency to decline a rental agreement with a qualified driver simply because of age. For example, a 20-year-old driver with considerable driving experience, a flawless driving record, and driving education certification may be prohibited from renting or may have to pay a hefty surcharge to do so. Furthermore, whether or not a person is judgment proof cannot solely be determined by the individual's age.

What is needed is a system and method for enabling individuals to certify their level of risk, thereby enabling them to rent vehicles from rental agencies without any hindrances. Additionally, what is needed is a system and method for providing a rental agency with a level of assurance of an individual's qualifications for a rental by receipt of certification information. Furthermore, what is needed is a system and method for providing to a rental agency a guarantee of reimbursement for a cost related to a certified individual's use of a rented vehicle.

### SUMMARY

A certification and risk-management system and/or method for a rental agreement, substantially as shown in and/or described in connection with at least one of the figures, as set forth more completely in the claims.

### BRIEF DESCRIPTION OF THE DRAWINGS

In order to describe the manner in which the above recited and other advantages and features of the invention can be obtained, a more particular description of the invention briefly described above will be rendered by reference to specific embodiments thereof that are illustrated in the appended drawings. Understanding that these drawings depict only typical embodiments of the invention and are not therefore to be considered limiting of its scope, the invention will be described and explained with additional specificity and detail through the use of the accompanying drawings in which:

FIG. 1 illustrates a general architecture overview of an embodiment of rental guarantee system.

FIG. 2 illustrates a general architecture overview of an embodiment of a certification entity.

FIG. 3 illustrates an example of an embodiment of enrolling an individual with a certification entity.

FIG. 4 illustrates an example of an embodiment of administering a rental agreement via a rental guarantee system.

FIG. 5 illustrates an example of an embodiment of reimbursing a rental agency via a rental guarantee system.

### DETAILED DESCRIPTION

Various embodiments of the invention are discussed in detail below. While specific implementations are discussed, it should be understood that this is done for illustration purposes only. A person with ordinary skill in the art will recognize that other components and configurations can be used without parting from the spirit and scope of the invention.

In general, the present invention provides a system and method that enables individuals, such as young drivers, to participate in agreements readily, such as vehicle rental agreements, in which they would normally be hindered. The present invention can accomplish this by screening applicants to determine their levels of risk. The screening procedure can include a multitude of factors. For example, an applicant can be requested to provide proof of insurance coverage, indicate his level of education, provide personal and business references, and indicate his level of income. The applicant can also be requested to allow the certification entity to access third party data, such as criminal records, driving history records, and financial information. An applicant can be requested to engage a guarantor: a person or organization that will be responsible for obligations that result from the applicant's participation in a rental agreement.

If the applicant provides the necessary information and if he is determined to have met the necessary criteria, he can be enrolled with the certification entity. The certification entity can provide the individual with a certification identifier, such as an identification code associated with a financial card or a membership card. The individual can then present the identifier at any participating agency to rent without restrictions (or with reduced restrictions). If the renter damages the rented vehicle, the certification entity can ensure the rental agency is reimbursed. The reimbursement can be funded by the renter's insurance provider, the renter, the renter's guarantor, or, if these default, by the certification entity's own resources.

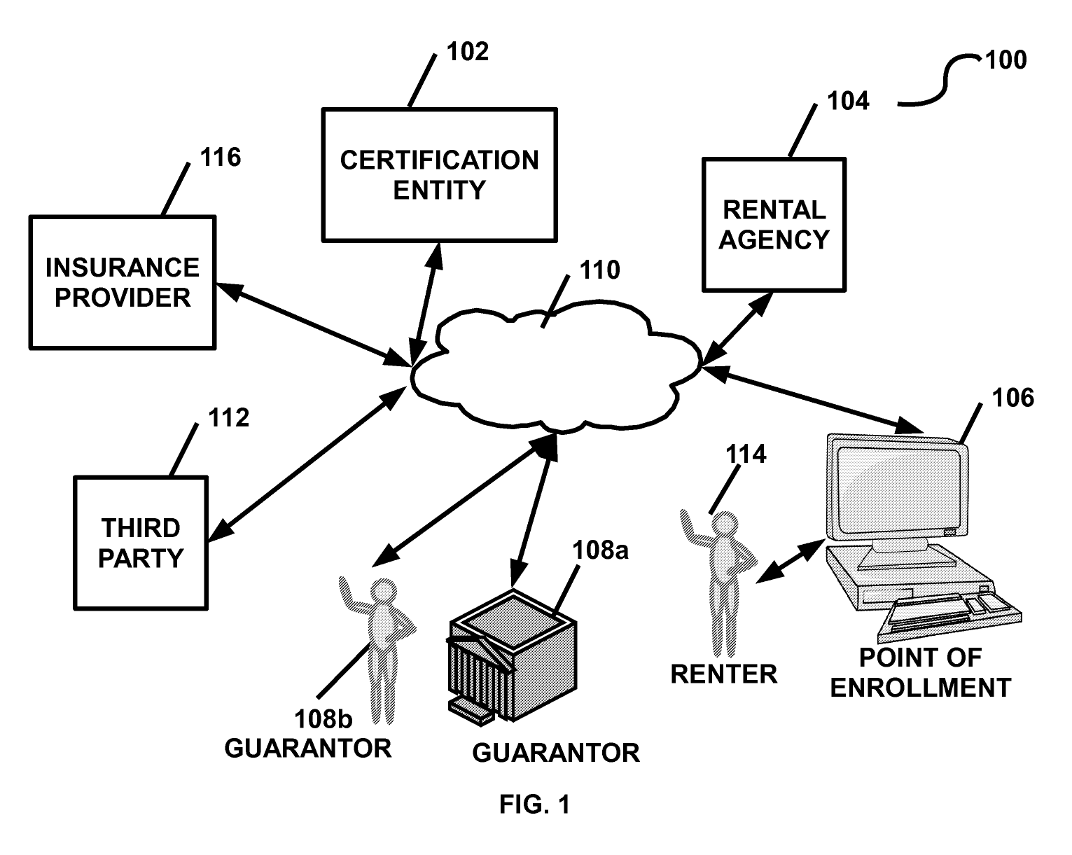

FIG. 1 illustrates a general architecture overview of an embodiment of rental guarantee system (RGS) 100. As will be described in detail below RGS 100 enables an effective method by which an individual can be certified as an acceptable risk for a rental agreement and by which a rental agency can be guaranteed reimbursement for one or more costs related to a certified individual's use of a rented vehicle. An individual, herein referenced as “renter 114,” wishing to utilize RGS 100 can apply at point of enrollment 106. Point of enrollment 106 can be any instrument enabled to receive data from renter 114, such as a personal computer, a mobile device (e.g., mobile phone, personal digital assistant, handheld computer, etc.), a kiosk, a customer service desk, a point of sale terminal, a telephone, or the like. Point of enrollment 106 can interact with certification entity 102 via network 110. The various entities of the RGS 100 can communicate and interact via network 110, which can be a wide area network, such as the Internet. In other embodiments, network 110 can be a local area network, a mobile network, or a telephone network. Network 110 can enable wired and/or wireless communication between system components. Alternatively, renter 114 can apply by submitting a document containing the necessary information, such as an application form, to certification entity 102.

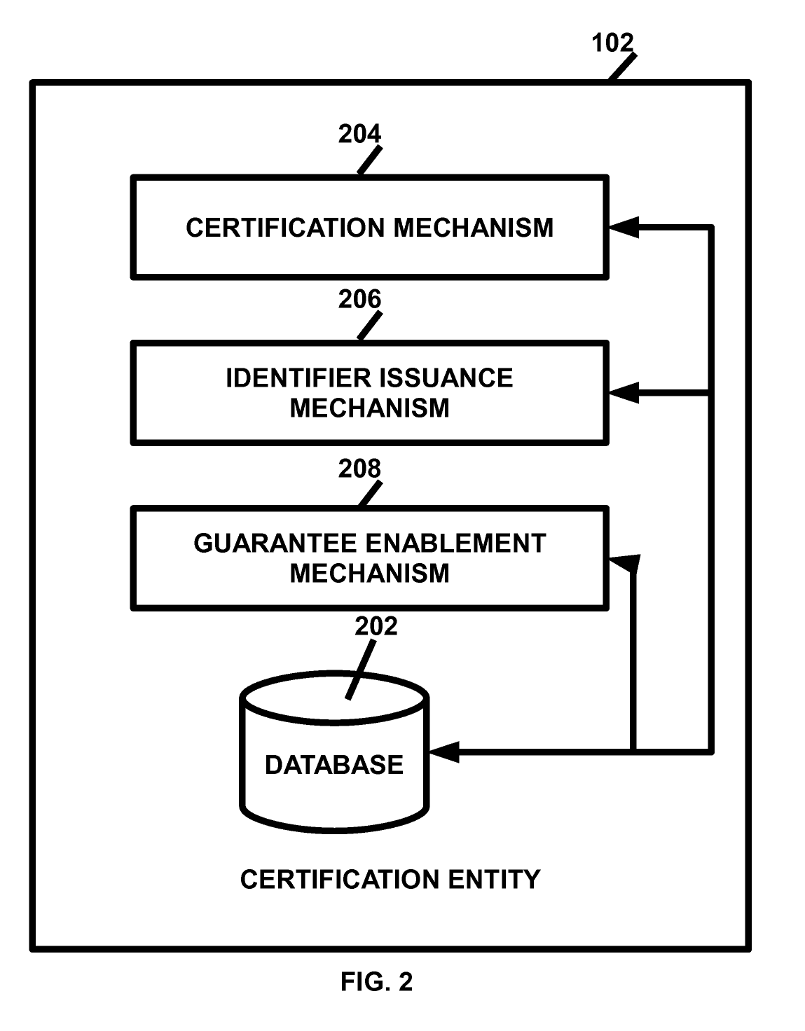

FIG. 2 illustrates a general architecture overview of an embodiment of certification entity 102. Certification mechanism 204 of certification entity 102 can employ data acquired regarding renter 114 to determine a level of risk for renter 114 for one or more rental agreements. The rental agreement can be one which would normally involve a restriction for renter 114. For example, the restriction may involve prohibiting renter 114 from renting or may require renter 114 to agree to a punitive condition, such as paying a surcharge. Certification entity 102 can include identifier issuance mechanism 206, which can enable certification entity 102 to issue a certification identifier, such as a code, to renter 114. The certification identifier can be associated with a token, device, biometric data, or the like. For example, the certification identifier can be included with a payment token issued to renter 114 and can be associated with the related financial account. Renter 114 can present the certification identifier to rental agency 104 to indicate he has been deemed an acceptable risk. Certification entity 102 can offer rental agency 104 a guarantee for reimbursement for one or more costs associated with renter 114's use of the vehicle during a rental period, such as costs for repairing damage to the vehicle that are not covered by insurance provider 116. Guarantee enablement mechanism 208 can enable the determination of the reimbursement owed by certification entity 102 and can enable the transfer of reimbursement funds to rental agency 104. Renter 114 can pay certification entity 102 an application fee and/or a periodic fee (e.g., a membership fee) in order to participate in the certification service. In one scenario, rental agency 104 can pay certification entity 102 a service fee and/or a referral fee. This fee can be less than the profit lost due to turning away potential customers, or an amount equal to or less than the discount rental agency 104 offers to corporate partners. In one scenario, certification entity 102 can serve as an intermediary between renter 114 and rental agency 104. As such, certification entity 102 can receive a service fee for handling the rental agreement. For example, certification entity 102 can function as part of an online rental reservation service.

Certification entity 102 can store information in database 202. Although only one database 202 is illustrated, this is not to be construed as limiting, as certification entity 102 can comprise multiple databases 202. Database 202 can store information relating to one or more renters 114, one or more rental agencies 104, one or more guarantors 108a/108b, one or more insurance providers 116, and/or one or more third parties 112.

A renter record holds renter data relating to renter 114 including, by way of illustration and without limitation, name, date of birth, age, driver's license data (including length of time since it was issued), social security number, home address, email address, telephone number(s), employment information, insurance information, driving history data, criminal record data, police record data, vehicle ownership history data, vehicle usage history data, driver's education data, academic education data, business reference data, personal reference data, employment data, financial data, age data, lifestyle data, biometric data (e.g., fingerprint, voice, hand, eye, face, DNA, etc), medical data, insurance data, and any other relevant data. In one embodiment, a renter record can include driver tracking data, such as information obtained via a global position system (GPS) device while renter 114 was operating a vehicle (e.g., his own vehicle, a rented vehicle, etc). A renter record can also include information related to interactions renter 114 has had with rental agencies 104 or with rental programs external to the system. For example, a rental record can include rental history data from rental agencies 104 or indicate whether renter 114 is enrolled in vehicle sharing programs, such as Zipcar. Renter data can be obtained from renter 114, one or more guarantors 108a/108b, one or more rental agencies 104, and/or one or more third parties 112. For example, third party 112 can be a credit reporting institution and can provide certification entity 102 with the credit score for renter 114. Additionally, certification entity 102 can verify information provided by renter 114 with data maintained at an external entity, such as guarantor 108a/108b or third party 112.

A rental agency record can hold information pertaining to rental agency 104, such as a name, identification data, phone number, address, or the like. The rental agency record can also include various criteria of rental agency 104, such as data pertaining to its rental policies and its rental agreements. A rental agency record can also indicate the types of vehicles available via rental agency 104, rental costs, agency locations, and the like.

A guarantor record can hold data relevant to guarantor 108a/108b, including a name, identification data, phone number, address or the like. A guarantor can be an individual (i.e., guarantor 108b), such as a relative, guardian, friend, individual employer, or coworker of renter 114. For example, guarantor 108b can be the parent of renter 114. Alternatively, the guarantor can be an organization (i.e., guarantor 108a), such as an employer, charity, or club associated with renter 114. For example, guarantor 108a can be a charity renter 114 participates in, such as Habitat for Humanity. Guarantor 108a/108b can be held responsible by certification entity 102 for one or more costs (e.g., repair costs) related to renter 114's use of a rented vehicle that are not covered by another party, such as insurance provider 116. As described further below, guarantor 108a/108b can be exempt from other matters related to renter 114, such as those associated with the personal liability of renter 114. The guarantor record can also include guarantor 108a/108b's financial account information and stipulate the level of responsibility guarantor 108a/108b has for renter 114. The guarantor record can also indicate the particulars of rental agreements for which guarantor 108a/108b agrees to guarantee the participation of renter 114.

An insurance provider record can include data related to insurance provider 116. Insurance provider 116 can be an insurance entity related to the particular types of rental agreements that certification entity 102 guarantees, such as an automobile insurance company. Renter 114 can authorize certification entity 102 to access insurance information maintained by insurance provider 116 during enrollment and from time to time after enrollment. An insurance provider record can include data related to insurance subscribers enrolled with certification entity 102, as well as data pertaining to subscribers who have applied with certification entity 102 but where declined or those who have been uncertified. Subscriber data can include an individual's payment history, accident history, coverage information, and the like. Alternatively, or additionally, insurance provider 116 can offer coverage to rental agency 104 and the insurance provider record can indicate relevant rental agencies 104.

A third party record can hold data associated with third party 112. Participating third parties 112 can provide certification entity 102 with access to driving records, criminal records, credit records, financial institution records, educational institution records, vehicle records, government records, military records, or the like. The particulars of the data maintained in a third party record can vary per the characteristics of the specific third party 112, but can include a name, identification data, or the like. Third party 112 can be associated with renter 114, rental agency 104, insurance provider 116, and/or guarantor 108a/108b. In one scenario, third party 112 can be a financial institution and RGS 100 can enable the transfer of a monetary value from one entity to another. For example, RGS 100 can enable a transfer of funds from a financial account of guarantor 108a/108b to certification entity 102. Although only one third party 112 is depicted in FIG. 1, this is for illustrative purposes and it is not to be construed as limiting, as multiple third parties 112 can interact with RGS 100.

As would be appreciated, one or more operators of RGS 100 can access RGS functions and/or records. For example, an operator can access renter records to verify renter registration data or to administer RGS 100 maintenance procedures.

Information transferred or stored in RGS 100 can be encrypted. For example, information can be encrypted at one point and sent across a non-secure connection between points or not encrypted at a point of communication and sent to the other point of communication across a secure connection. Encryption and decryption of these messages can be monitored by services provided by a security company such as VeriSign.

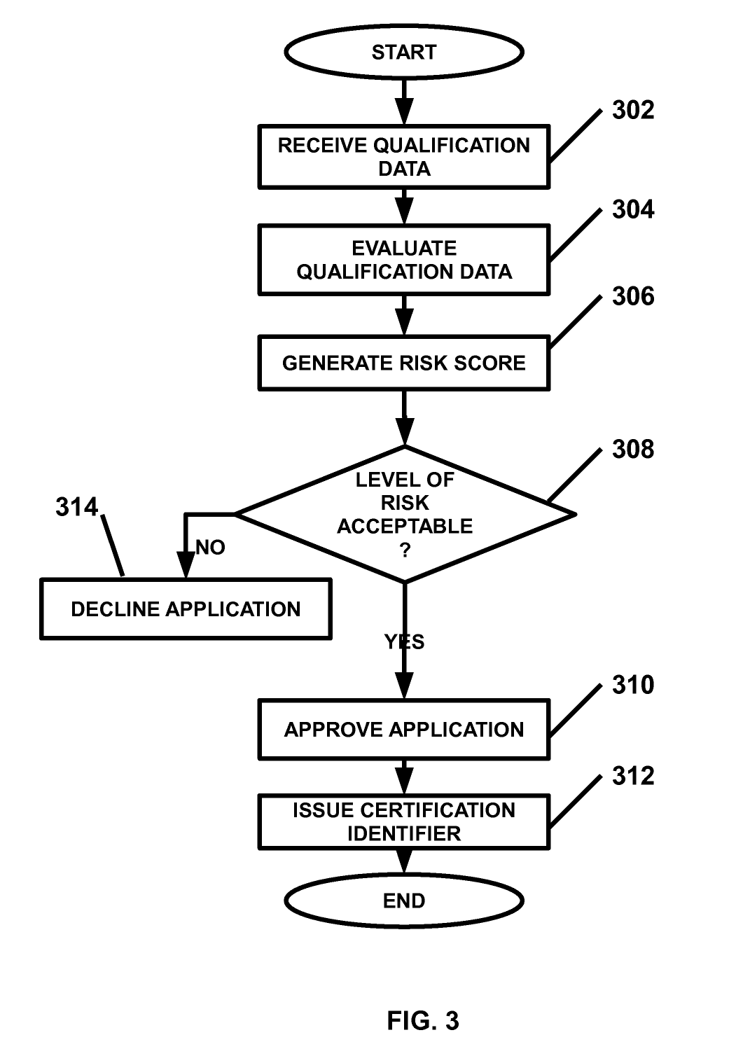

FIG. 3 illustrates an example of an embodiment of enrolling an individual with certification entity 102. Certification entity 102 can receive qualification data from renter 114 via point of enrollment 106 (step 302). For example, renter 114 can access a certification entity Web site via his personal computer or at a kiosk located at a rental agency location. Renter 114 can provide all the necessary qualification data at one session or can be allowed to present it over multiple sessions. Renter 114 need not be limited to using the same implementation of point of enrollment 106 for separate enrollment sessions. For example, renter 114 can begin enrollment on a personal computer and complete it via a mobile device.

Renter 114 can provide various data elements indicative of his identity, such as name, social security number, biometric data, address, phone number, email address, date of birth, age, and other identifying data. Renter 114 can also provide medical data, such as medical history, health insurance information, current or past medical conditions, or the like. Renter 114 can provide data indicative of vehicle use, such as how long he has had a driver's license, details about his driving experiences (e.g., whether he commutes to work, is he responsible for transporting others, etc.), and information related to his participation with rental programs (regardless of whether they are affiliated with RGS 100). Renter 114 can provide details of vehicle ownership, such as whether he owns his vehicle, whether he has used another person's vehicle, and the like. Renter 114 can indicate whether he has undergone any kind of driver's education and, if so, the particulars of the education provider (e.g., name, duration of the course, whether he graduated, etc.). Certification entity 102 can verify the driver's education data provided, such as with its own records or by accessing third party 112, to determine whether the data provided is legitimate and to assess the quality of the driver's education course attended. Renter 114 can also provide information regarding his academic education, such as the highest level obtained, his grade point average, school ranking, and whether he has a diploma.

In one embodiment, certification entity 102 can offer a rental procedure education course that can instruct renter 114 in proper rental etiquette and explain the expectations of the parties involved. The rental procedure education course can be provided in a various formats, such as a classroom course, an online tutorial, or the like. Renter 114 can be required to participate in this course in order to obtain certification. Alternatively, participation in the course can be required only if the qualification data of renter 114 indicates that he is not a strong candidate for certification.

Renter 114 can indicate the particulars of his work history, such as current and past employers, length of employment overall and/or with a particular employer, whether he currently works (and, if so, full or part time), salary information, and the like. Furthermore, renter 114 can provide financial information, such data regarding one or more financial accounts, amount of debt, expenditures (e.g., monthly or yearly bills), income, credit score, and the like.

Renter 114 can be requested to enable certification entity 102 to access data that is held by one or more third parties 112. For example, certification entity 102 can access a third party 112 that is a financial information provider, such Experian, Equifax, or TransUnion, to obtain credit status information and other financial data. As another illustration, certification entity 102 can access a third party 112 to determine whether renter 114 has bounced any checks (and if so, how many) or to determine if renter 114 has a bankruptcy or foreclosure on record. Certification entity 102 can request permission to access driving history records from the Department of Motor Vehicles (DMV) or other organizations that provide such data. For example, certification entity 102 can access DMV records to determine if renter 114 has any points associated with his driver's license. Certification entity 102 can also request access to police records to determine the presence of a criminal record. For example, certification entity 102 can determine if renter 114 has ever received a citation for driving while under the influence of controlled substances (DUI). Certification entity 102 can be enabled to access other government sources as well. For example, certification entity 102 can determine the immigration status of renter 114. As another illustration, certification entity 102 can be permitted to access government records pertaining to firearm purchases. If renter 114 has been prohibited from purchasing a firearm, he can be considered a high risk. Certification entity 102 can also be enabled to access the records one or more government watch lists, such as a terrorist watch list, as well as non-government watch lists, such as those maintained by rental agencies, financial institutions, or the like.

Renter 114 can also authorize certification entity 102 to access one or more insurance providers 116, such as by indicating his insurance provider 116 and providing his policy number. Certification entity 102 can access records of insurance provider 116 to ascertain data associated with renter 114, such as original date of coverage, extent of coverage (e.g., comprehensive and collision, liability, etc.), insurance history data, whether he has been involved in any accidents, and how great of a risk insurance provider 116 deems renter 114 to be. Renter 114 can also provide data associated with previous insurance coverage.

Renter 114 can provide information indicative of his character. He can provide business references, such as current and past employers and coworkers, and/or personal references, such as friends, family, neighbors, and teachers. Renter 114 can provide a reference's identifying information, such as a name, mailing address, email address, and one or more phone numbers. Renter 114 can be prompted to provide information regarding his lifestyle. For example, renter 114 can be required to indicate activities he participates in, relationship information, choice of music, and other information that might directly or indirectly indicate a tendency for risky behavior. For example, being involved in “extreme” sports, such as skydiving, may be indicative of an inclination for risk taking.

In addition to information about renter 114, certification entity 102 can request qualification data regarding guarantor 108a/108b. As aforementioned, a guarantor can be an individual (i.e., 108b) or an organization (i.e., 108a). Guarantor 108a/108b can be held responsible for an obligation that results from renter 114's participation in a rental agreement with rental agency 104. Guarantor 108a/108b can be financially responsible for a portion of any costs incurred by certification entity 102 due to use of a rented vehicle by renter 114. For example, guarantor 108a/108b may be obligated to reimburse certification entity 102 for a monetary value it provided to rental agency 104 to cover the cost of repairs to the rented vehicle. In one scenario, in addition to, or instead of, being responsible for costs incurred due to renter 114's use of the vehicle, guarantor 108a/108b can be held accountable for the authenticity of the information renter 114 provides during enrollment. There can be one or more limits to the level of responsibility of guarantor 108a/108b. For example, there may be a monetary limit or guarantor 108a/108b may not be held responsible for criminal activity in which renter 114 participates in association with the rental. As another example, guarantor 108a/108b may not be held responsible if renter 114's use of the vehicle results in a death. In one embodiment, more than one guarantor 108a/108b can be associated with renter 114 and each guarantor 108a/108b can have his/its own responsibility criteria.

Guarantor data can be provided by guarantor 108a/108b, by renter 114, or a combination thereof. For example, renter 114 can provide contact information for guarantor 108a/108b and certification entity 102 (or an operator of certification entity 102) can contact guarantor 108a/108b to obtain the necessary information. In another scenario, renter 114 can provide all the needed information regarding guarantor 108a/108b and certification entity 102 (or an operator of certification entity 102) can contact guarantor 108a/108b to verify its authenticity. In yet another scenario, renter 114 can provide a portion of data regarding guarantor 108a/108b, while guarantor 108a/108b can be required to provide other data. Guarantor 108a/108b can be subject to screening criteria similar to those employed for renter 114.

In one scenario, guarantor 108a/108b can be given the authority to determine the particulars of the rental agreements with which renter 114 can participate. Guarantor 108a/108b can be provided with a list of criteria regarding particular rental agreements, such as vehicle particulars, destination types, rental durations, particular dates or days of the week, rental fees, and the like, and guarantor can select the criteria for the rental agreements he wishes to guarantee. For example, guarantor 108a/108b may not wish renter 114 to rent sport cars or may not want renter 114 to rent vehicles in known Spring Break destinations. Guarantor 108a/108b can indicate his permissions and limitations in various ways. For example, guarantor 108a/108b can access a certification entity Web site and type in particular limitations in a form field, select various options from a list of checkboxes, or select various options from a menu. Additionally, or alternatively, guarantor 108a/108b can authorize guarantor provider 102 to contact him when renter 114 initiates a rental agreement request so that guarantor 108a/108b can choose whether to serve as a guarantor for that particular rental agreement and/or to indicate a limitation to impose on the rental. As will be described below, guarantor 108a/108b can receive such notifications via email, via his mobile device, or the like. In one scenario, guarantor 108a/108b can select to receive notifications for other renter 114 interactions with the system, such as updates to the renter record. If renter 114's use of certification entity 102 involves the use of a payment token, guarantor 108a/108b can be notified when the payment token is employed for all transactions or for particular ones.

Once the necessary qualification data has been received, certification mechanism 204 of certification entity 102 can evaluate it per one or more established criteria (step 304). Depending upon implementation, certain criteria can be given more weight in the assessment. For example, guarantor data can be given more weight than the amount of time since driver's license issuance. The presence of a DUI citation can be given substantial weight relative to other criteria. In one scenario, only guarantor data is assessed. Various weighting configurations can be established per the criteria of certification entity 102 so that an accurate assessment can be generated. Certification mechanism 204 can determine a level of risk per this assessment (step 306), which can be employed to determine if renter 114 is an acceptable risk (step 308). For instance, certification mechanism 204 can determine whether the level of risk meets a particular risk threshold requirement. In one embodiment, certification mechanism 204 can generate a risk score reflective of the level of risk of renter 114, however, this is not to be construed as limiting as any measurement of risk can be employed. If the level of risk is indicative of renter 114 being an acceptable risk, the application can be approved (step 310). Otherwise, the application can be declined (step 314). In one scenario, if declined, renter 114 can be informed of one or more actions he can take in order to qualify. For example, renter 114 may be instructed to find a more suitable guarantor 108a/108b or obtain better or additional insurance coverage. In one scenario, the application can be approved conditionally. For example, the application may be approved with limited functionality until certification entity 102 has confirmed one or more elements of the qualification data (e.g., contacted personal references, verified the validity of the guarantor 108a/108b, etc.) or until renter 114 has provided one or more elements of qualification data that are lacking.

Once renter 114 is determined to be an acceptable risk, certification entity 102 can activate his renter record in database 202 and renter 114 can receive the associated benefits. Although renter 114 can be certified as an acceptable risk, certification entity 102 can limit the extent of this certification. The particulars of the certification can be relayed to renter 114 so that he can be aware of the breadth of his certification, including restrictions, permissions, and the like. Alternatively, as described below, certification entity 102 can relate the level of risk for renter 114 to rental agency 104 so that rental agency 104 can determine limitations (if any). For example, renter 114 can be limited to certain types of vehicles, such as being prohibited from renting luxury or sports cars, and/or being limited to renting vehicles equipped with tracking mechanisms that monitor driving patterns, speed, or the like. In one embodiment, certification entity 102 can be designed to turn on a tracking device that is associated with the user (e.g., phone) or the vehicle. As another illustration, certification entity 102 can decline to certify renter 114 for rental agreements involving certain areas, such as particular geographic locations or high-risk destinations (e.g., Daytona Beach during Spring Break, New Orleans during Mardi Gras, one or more foreign locations, traveling in the path of an impeding hurricane, etc.).

Identifier issuance mechanism 206 of certification entity 102 can issue a certification identifier to renter 114 to indicate that he has been enrolled (step 312). The certification identifier can be an identification code and can be associated with a token, such as a card, fob, smartcard, RFID-enabled device, or the like. In one scenario, the certification identifier can be an application, digital certificate, or the like, stored on renter 114's personal device (e.g., mobile phone, PDA, personal computer). Alternatively, the certification identifier is not associated with anything other than the renter record for renter 114. In one embodiment, an existing code associated with renter 114 can be employed as the certification identifier. For example, a driver's license number can serve as the certification identifier. Alternatively, the certification identifier can be associated with data pertaining to guarantor 108a/108b, such as identification information or an account number. In addition to the certification identifier, the particulars of the certification can be associated with a token. For example, such data can be stored or encoded on the token or a data element on the token can be employed to locate the data stored in a renter record.

In one embodiment, the certification identifier can be associated with a financial account (e.g., a credit card account, a corporate account, etc.) and, if applicable, the related payment token. The certification identifier can be all or a part of the financial account number. For example, the certification identifier can be the account number on a payment token or a portion of the account number (e.g., bank identification number (BIN)). The certification identifier can also be composed of two or more pieces of information, such as a portion of the account number and other data, such as the birthday of renter 114. The enrollment process described above can be part of an application for the financial account and the certification entity 102 can be affiliated with, or function as a part of, a financial institution, such as a bank or a credit card issuer. One or more portions of the qualification data received can be employed for determining whether renter 114 is eligible for registration with certification entity 102 and if renter 114 is qualified for the financial account. Alternatively, qualifying for the financial account can be a separate process handled by a separate entity (e.g., a credit card issuer or a company). If so, the results of the financial account qualification process can be received by certification entity 102 and can be employed when certifying renter 114. Likewise, the results of the certification process of certification entity 102 can be provided to the financial account entity so that it can use the data in its qualification determination. The renter 114 can be issued a payment token (associated with the certification identifier) after enrollment approval. In one scenario, the payment token can include a logo or other representation associated with certification entity 102.

In one scenario, the certification identifier can remain valid as long as renter 114 remains in good standing with certification entity 102. Alternatively, the certification identifier can expire. For example, the certification identifier can expire after a particular time period or when one or more elements of enrolled qualification data expire, such as at a driver's license expiration date or when insurance coverage expires. From time to time, certification entity 102 can access DMV records (e.g., third party 112) or insurance provider 116 to determine the validity of such enrolled qualification data. The certification identifier can be renewed after such an element is also renewed.

In addition to expiration, renter 114 can also lose certification if data obtained subsequent to enrollment indicates that renter 114 is no longer an acceptable risk. From time to time, certification entity 102 can access one or more third parties 112, insurance providers 106, rental agencies 104, or the like, to recertify renter 114. Certification entity 102 can employ data obtained from one or more of these sources to update the level of risk of renter 114 in order to ensure renter 114 is still qualified for certification. If the level of risk fails to meet a certain threshold, renter 114 can lose his certification. Recertification can involve evaluating one or more updated elements of previously enrolled qualification data or it can involve the evaluation of new data associated with renter 114. For example, loss or cancellation of an insurance policy, a new incident on a criminal record, a negative change in his credit score, a bankruptcy filing, a negative change in education data (i.e., a lower GPA than when enrolled or ceasing to attend school), a change in work status, or the like. In one scenario, certification entity 102 can interact with insurance provider 106 to determine if there has been any change in the level of coverage for renter 114. In another scenario, certification entity 102 can interact with a government database, such as one maintained by the DMV or the police, to examine the driving record or accident history of renter 114 or to determine if there are changes to the criminal record of renter 114. Certification entity can access other government sources to determine if renter 114 has been added to any watch lists, such as those pertaining to restricted access to firearms, to travel, suspected terrorists, or the like. Rental agency 104 can provide certification entity 102 with information regarding the behavior of renter 114 during a rental period. As certification entity 102 can serve more than one rental agency 104, including those that might be in competition, the amount of renter data employed can be limited. For example, rental agency 104 may permit certification entity 102 only to employ negative data universally. Renter 114 can be uncertified if he causes damage to a vehicle during a rental that has been certified by certification entity 102. Furthermore, renter can be uncertified if he violates a rental agreement one or more times. The effect of a particular incident on the level of risk can vary, such as per the severity of the incident. For example, if renter 114 is involved in a “fender bender” in which minimal damage is done to the vehicle, his level may only be adjusted slightly or not at all. Conversely, a single, severe incident can cause immediate disqualification, such as if renter 114 causes a multiple vehicle accident. Individuals can also be enabled to provide certification entity 102 with information regarding renter 114. For example, a rental vehicle may have a bumper sticker with a phone number so that other drivers can report poor driving on the part of renter 114. In addition to negative information, an entity can provide positive information that can have a positive effect on the level of risk of renter 114. For example, a charity in which renter 114 participates or the employer of renter 114 can provide certification entity 102 with positive data. As another illustration, a financial institution can report a positive change in renter 114's credit status.

In addition to reevaluating data associated directly with renter 114, certification entity 102 can reevaluate data associated with guarantor 108a/108b. If certification entity 102 determines guarantor 108a/108b is no longer qualified, the level of risk for renter 114 can be affected.

Certification entity 102 can provide certification for various types of rentals. For example, certification entity 102 can certify renter 114 for renting one or more of automobiles, watercraft, motorcycles, and the like. Certification 102 can also be employed for rentals that do not pertain to vehicles, such as apartments, vacation homes, power tools, and the like. In one scenario, the behavior of renter 114 during one type of rental can affect his level of risk for one or more other types of rentals. For example, abusive behavior during a Jet Ski rental can affect the level of risk for renter 114 for automobile rentals. In one embodiment, although certification entity 102 can receive data associated with various rental types during enrollment or subsequently, it can only offer certification for one or more particular kinds of rentals. For example, certification entity 102 may evaluate data obtained from a Jet Ski or golf car rental services when determining a level of risk of renter 114, but it may only offer its certification services for rentals associated with automobiles.

As aforementioned, the certification identifier can be associated with a financial account. In one scenario, if after recertification the level of risk for renter 114 fails to meet the required threshold, the financial capabilities of the account can be restricted. For example, the use of the associated payment token can be restricted so that it cannot be used with certain enterprises or, in the case of a credit account, the credit limit can be lowered. In one scenario, the financial account may no longer be used to pay for rental transactions. Restricted and permitted enterprises can be determined, for example, by evaluating the Standard Industrial Classification (SIC) code associated with the enterprise.

Renter 114 can be allowed to restore his certification if he undertakes one or more specified actions (e.g., obtains greater insurance coverage, maintains a clean driving record for a specific period of time, etc.). Conversely, positive information provided by one or more third parties 112, insurance providers 106, rental agencies 104, or the like, can affect the level of risk of renter 114 in a positive fashion, thereby possibly enabling renter 114 to receive reduced restrictions for a wider range of rental agreements.

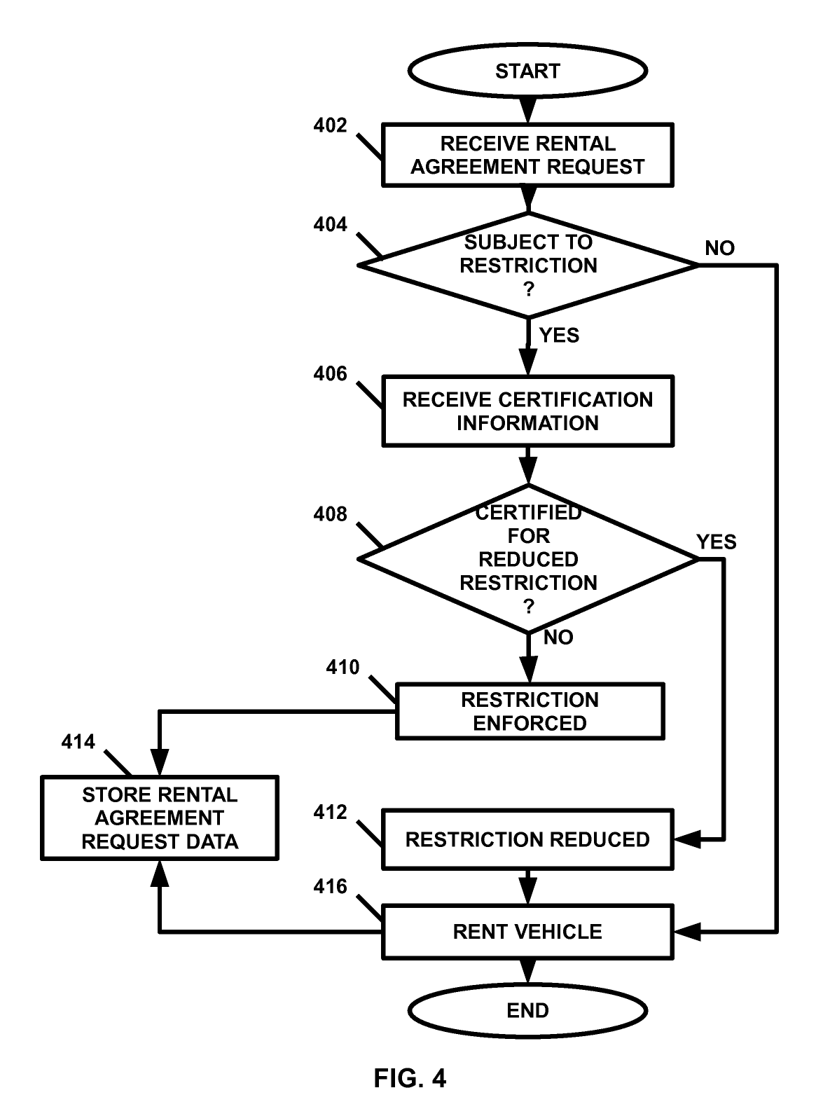

FIG. 4 illustrates an example of an embodiment of administering a rental agreement via RGS 100. Once enrolled with certification entity 102, renter 114 can rent a vehicle at a participating rental agency 104. Renter 114 can initiate the rental agreement request at a brick and mortar location, via the phone, via the Internet, or the like. Although the process described herein is described mainly in terms of renter 114 interacting directly with rental agency 104, this is not to be construed as limiting. As aforementioned, certification entity 102 can serve as an intermediary between renter 114 and rental agency 104 and can handle one or more portions of the process for rental agreement initiation. Renter 114 can provide details requested by rental agency 104, such as name, address, driver's license data, method of payment, age, date of birth, insurance provider data, and the like. Once rental agency 104 receives the request from renter 114 to participate in a rental agreement (step 402), rental agency 104 can determine whether renter 114 is subject to a restriction (step 404). A restriction can be a policy enforced by rental agency 104 that can prevent renter 114 from participating in the rental agreement or it can involve requiring renter 114 to agree to a punitive measure in order to participate in the rental agreement, such as paying an additional fee and/or agreeing to one or more limitations. For example, rental agency 114 can determine whether renter 114 meets a particular age criteria. If renter 114 is determined not to be subject to a restriction, rental agency 104 can approve the rental agreement request and rent the vehicle to renter 114 (step 416). If renter 114 is determined to be subject to a restriction, rental agency 104 can prompt him to provide certification information, including a certification identifier, to determine if renter 114 is certified for a reduction in the restriction. Alternatively, renter 114 can provide a certification identifier with his initial request. For example, renter 114 can input his certification identifier into a rental agency Web site, verbally provide his certification identifier via the phone, or can provide a certification identifier token at a rental counter. As aforementioned, the certification identifier can also be included with the account number of a financial account and, thus, renter 114 can provide payment information and his certification identifier simultaneously.

In one embodiment, certification for a reduction to a restriction to the rental request can also be dependent upon renter 114 presenting certification information in addition to the certification identifier. For example, renter 114 may be prompted to provide driver's license data or other qualification data (e.g., rental history data). As another example, renter 114 can be prompted to provide certification information regarding the particulars of his certification, such as vehicle type restrictions, date restrictions, and the like. One or more elements of certification information can be obtained from a token. For example, a token may be encoded with the certification identifier and rental restriction and permission data, or the token can allow access to certification information held in database 202.

Once rental agency 104 has received the certification information, including the certification identifier (step 406), it can employ it to determine if renter 114 is certified to participate in the requested rental agreement with a reduction to the restriction. For example, renter 114 can be allowed to participate in a rental agreement he normally could not or he can be allowed to participate with a lessened surcharge (step 408). In one scenario, the presence of a certification identifier can be sufficient to indicate renter 114 is certified. For example, if the account number of the payment token presented by renter 114 includes the certification identifier, renter 114 may need simply to present the payment token to rental agency 104 and rental agency 104 could automatically ascertain that renter 114 is certified. If certification entity 102 serves as an intermediary between renter 114 and rental agency 104, the transmission of the rental request from certification entity 102 to rental agency 104 can serve to certify renter 114, rather than the provision of a specific certification identifier. For example, certification entity 102 can limit its rental reservation services to certified renters 114 and, as such, rental agency 104 can be assured that any rental request received from certification entity 102 involves a certified renter 114. Alternatively, the certification identifier can be verified to determine its authenticity. For example, rental agency 104 can relay the certification identifier to certification entity 102. The determination of whether the certification identifier is a valid one can be sufficient for certifying renter 114 as eligible for the restriction reduction. Alternatively, certification entity 102 can employ the certification identifier as a reference to locate the renter record of renter 114. The presence of an active renter record, as opposed to an inactive one, can be sufficient to determine certification. The records of individuals who failed to meet enrollment qualifications or those whose behavior has rendered them uncertified can be associated with a negative list and their records can be marked inactive, while individuals who met enrollment qualifications or whose behavior has maintained their certification can be associated with a positive list and their records can be marked active. For example, the renter record of an individual whose automobile insurance has expired can be marked inactive. In another scenario, certification entity 102 can determine whether the current data stored in the record, such as data pertaining to a level of risk, is indicative of renter 114 being presently certified. For example, certification 102 can make a real-time decision regarding the certification of renter 114 and can relay the results of the assessment to rental agency 104. The assessment can be a positive or negative indication. In an alternate scenario, certification entity 102 can provide rental agency 104 with a recommendation, indicating whether it will certify renter 114 for the rental agreement. For example, the recommendation can be color coded, with green indicating renter 114 is certified, red indicating he is not, and yellow indicating his level of risk is indeterminate. Rental agency 104 can act upon the recommendation as it chooses, but initiating a rental agreement with someone who is not certified or whose level of risk is indeterminate can relieve certification entity 102 of its guarantee obligations.

In one embodiment, if renter 114 is determined to be certified for a restriction reduction, the amount the restriction is reduced can be based upon his level of risk. Certification entity 102 or rental agency 104 (via data provided by certification entity 102) can segment rental options for renter 114, per his level of risk, into those allowed and those which are prohibited. The rental agreement can be adjusted per the segmentation and renter 114 can be presented with the option of participating. For example, the type of vehicle(s) available to renter 114 may be determined by his level of risk and a high-risk renter 114 may only be offered an economy class vehicle. Other possible rental options can pertain to the duration, time of day of the rental, or the like. A rental option can also pertain to a particular time frame, such as a calendar date, a season, a holiday, or the like. For example, renter 114 may be restricted from renting a vehicle during Spring Break. A rental option can pertain to the amount of mileage allowed during the rental. In one scenario, the rental option can pertain to the use of a vehicle tracking mechanism, such as a GPS mechanism. Renter 114 can be required to allow the use of a vehicle tracking mechanism if he is determined to be a high-risk.

As aforementioned, determining whether renter 114 is certified for the restriction reduction can be based in part, or completely, by authorization of guarantor 108a/108b. If guarantor 108a/108b has established authorization criteria during or subsequent to enrollment, the particulars of the rental agreement request can be compared with this authorization criteria and the request can be approved or declined accordingly. Alternatively (or additionally), guarantor 108a/108b can be notified of the rental agreement request. For example, certification entity 102 can notify guarantor 108a/108b automatically via a message transmitted to a mobile device, an email address, or via automated phone call. Alternatively, an operator of certification entity 102 can manually transmit the notification. The notification can include the particular options of the rental agreement request, such as the type of vehicle, the destination, the duration, or the like. Guarantor 108a/108b can respond to certification entity 102 and indicate whether he permits or prohibits the restriction reduction. Additionally, guarantor 108a/108b can include one or more restrictions in his response. For example, guarantor 108a/108b can indicate he will agree to serve as a guarantor for the rental agreement only if renter 114 selects a different vehicle. Certification entity 102 can provide supplemental messages indicating whether or not renter 114 has accepted the restriction.

In one embodiment, rental agency 104 can maintain renter records and can determine renter certification itself. For example, certification entity 102 can provide participating rental agencies 104 with renter record data from time to time so that rental agency 104 can determine certification locally. Although certification entity 102 has typically been described herein as an independent entity, this is not to be construed as limiting. In one scenario, certification entity 102 is related to one or more rental agencies 104. For example, certification entity 102 can be operated by rental agency 104 and rental agency 104 can offer certification to its customers and the customers of affiliates. The rental agency 104 can also employ its own certification entity 102 to obtain reimbursement from a guarantor 108a/108b, as described below.

If renter 114 is determined to not be certified, the restriction is enforced (step 410). Although not depicted in FIG. 4 for the sake of clarity, if the restriction does not prohibit renter 114 from renting the vehicle outright, he can rent the vehicle if he is willing to accept the restriction (e.g., agree to a surcharge). If renter 114 is determined to be certified, the restriction is reduced (step 412) and renter 114 can rent the vehicle with a lessened restriction or no restriction at all (step 416). Once the rental agreement request has been approved, or declined, data pertaining to the rental agreement request can be stored in association with the record of renter 114 (step 414). The data stored can indicate the particulars of the agreement, such as the time, date, duration, vehicle data, destination data, destination contact information, transaction amount, and the like.

As aforementioned, the certification identifier can be associated with a financial account and the financial account can be employed to pay for the rental transaction.

Rental agency 104 can be enabled to provide certification entity 102 with information regarding the rental. Such information need not be related to a reimbursement attempt (see below), but can indicate how well renter 114 fulfilled rental agreement obligations. For example, rental agency 104 can indicate the state of the vehicle when it was returned, the ease of dealing with renter 114, whether the vehicle was returned with a full tank of fuel, and the like. Rental agency 104 can be enabled to provide such information via a Web site, via phone, via mail, via email, or the like. This information can be associated with the renter record of renter 114 and can be used when determining his eligibility for a restriction reduction in subsequent rentals.

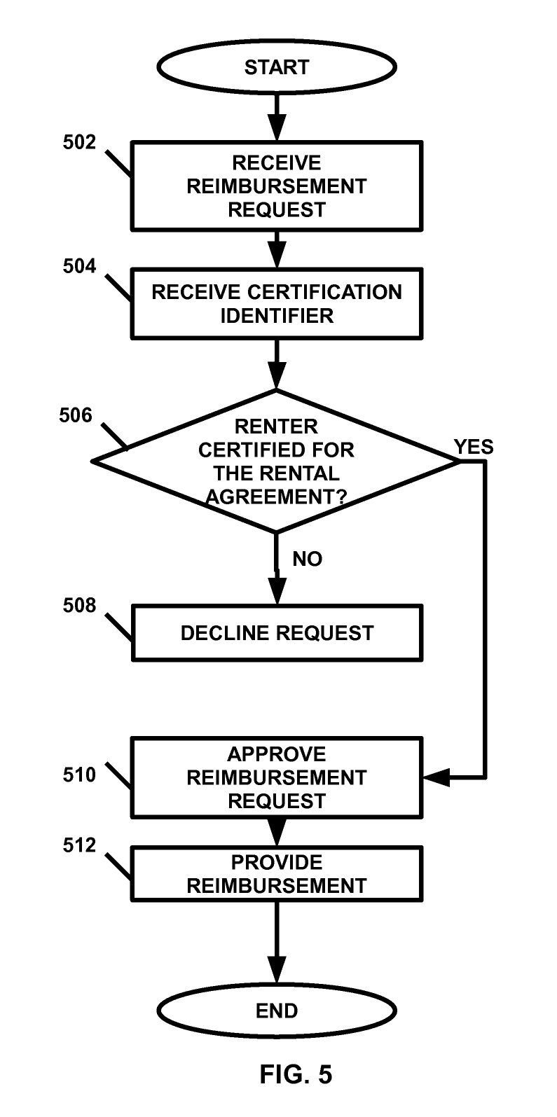

If rental agency 104 incurs a cost related to renter 114's use of the vehicle, RGS 100 can enable reimbursement. FIG. 5 illustrates an example of an embodiment of reimbursing rental agency 104 via a RGS 100. For example, renter 114 may cause damage to the rented vehicle and rental agency 104 may want to be reimbursed for the costs of repairing the damage. To obtain reimbursement, rental agency 104 can submit a request to certification entity 102. In one scenario, the amount of the requested reimbursement can be the balance owed to rental agency 104 after rental agency 104 has received moneys from other entities associated with the rental. For example, rental agency 104 can first obtain a monetary amount from insurance provider 116 to cover repairs costs for the rental vehicle. In another example, rental agency can first obtain a monetary amount from a third party 112, such as a credit card issuer that provides renter 114 with rental coverage as a perk. The rental agency 104 can then submit a reimbursement request to certification entity 102 for any amount not covered by insurance provider 116 or third party 112. Alternatively, rental agency 104 can submit a reimbursement request for the total cost and certification entity 102 can obtain monetary values from insurance provider 116 or third party 112 in addition to guarantor 108a/108b. When certification entity 102 receives the request (step 502), it can prompt rental agency 104 to provide the certification identifier associated with the renter 114. Alternatively, rental agency 104 can provide the certification identifier with the initial reimbursement request. When certification entity 102 receives the certification identifier (step 504), guarantee enablement mechanism 208 can determine if renter 114 was certified for the rental agreement (step 506). Guarantee enablement mechanism 208 can access the record of renter 114 by employing the certification identifier as a reference. In one scenario, the presence or absence of an associated, active renter record can be sufficient to determine if the rental agreement had been certified. Alternatively, guarantee enablement mechanism 208 can assess the contents of the associated renter record to determine if renter 114 was certified. For example, the renter record can include data regarding the particulars of the rental agreement and whether certification entity certified a restriction reduction associated with the rental agreement. If guarantee enablement mechanism 208 determines renter 114 was not certified for the rental agreement, the reimbursement request can be declined (step 508). If guarantee enablement mechanism 208 determines that renter 114 did participate in the rental agreement and was certified by certification entity 102, the reimbursement request can be approved (step 510). The guarantee enablement mechanism 208 can provide the reimbursement in a various manners (step 512). In one scenario, reimbursement is provided via an electronic transfer from the financial account of certification entity 102 to that of rental agency 104. Alternatively, reimbursement can be provided manually, such as by a paper check. The actual amount reimbursed can depend upon the agreement between certification entity 102 and rental agency 104. In one scenario, certification entity 102 is obligated to provide the full amount owed. In another scenario, certification entity 102 is obligated to provide only a monetary value for costs not covered by the insurance provider(s) 116 of rental agency 104 and/or renter 114 or not covered by a relevant third party 112 (e.g., a credit card issuer).

Certification entity 102 can obtain reimbursement for its own expenditures from renter 114, guarantor 108a/108b, insurance provider 116, or any combination. Certification entity 102 can obtain this reimbursement via electronic transfer or manual means. In one scenario, renter 114 and/or guarantor 108a/108b can also be obligated to pay a fee in addition to the amount certification entity 102 provided to rental agency 104. If certification entity 102 has difficulty obtaining reimbursement, it can employ a collection agency or similar means to ensure it receives the money it is owed. In one scenario, certification entity 102 can reimburse rental agency 104 after it itself has received a monetary value to cover the cost of the reimbursement.

In one embodiment, in addition to the aforementioned procedures, certification entity 102 can employ RGS 100 to offer insurance products to renter 114, guarantor 108a/108b, or rental agency 104. For example, certification entity 102 can offer insurance to cover situations that the insurance policy of renter 114 does not. As another illustration, certification entity 102 can offer renter 114 an insurance product that supplants an insurance service offered by rental agency 104. The insurance products offered by certification entity 102 can be paid for via a surcharge in addition to a normal service fee. Certification entity 102 can offer the insurance coverage itself or can serve as an intermediary for an affiliate.

In one embodiment, in addition to enabling renter 114 to rent vehicles readily, certification by certification entity 102 can enable renter 114 to receive discounts on various services at participating merchants (including, but not limited to, participating rental agencies 104).

In addition to the system components described above, RGS 100 can interact with a usage-appropriate insurance system. A usage-appropriate insurance system can charge subscribers based upon their actual driving behavior, as indicated by GPS tracking and other tracking mechanisms. Data collected by the usage-appropriate insurance system can be relayed to certification entity 102 so that it can update the level of risk of renter 114 accordingly. For example, if renter 114's insurance coverage is adjusted per his actual driving behavior, his renter level of risk can be affected accordingly.

In one embodiment, a mobile device (e.g., mobile phone) enabled with a tracking mechanism, such as GPS, can be employed to monitor the driving behavior of renter 114. Certification entity 102 can be authorized to receive tracking data when renter 114 is operating a rental vehicle or when renter 114 operates any vehicle and the tracking can be passive or it can be active only upon initiation by renter 114. For example, the tracking data can indicate the frequency with which renter 114 obeys speed limits and traffic laws, instances of rapid acceleration or deceleration, and the like. Certification entity 102 can encourage renter 114 to provide tracking data by the offering a reward (e.g., gifts, discounts to service fees, etc.). In one scenario, the rental agreement request can be conducted via the mobile device. The mobile device can belong to renter 114 or rental agency 104 or certification entity 102 can provide renter 114 with the mobile device on a long-term or short-term basis (e.g., for the length of membership or the rental period). If so, and if renter 114 is certified to participate in the rental agreement and he authorizes certification entity 102 to monitor his behavior, renter 114 can employ various features of the mobile device during the rental period (e.g., calling, text messaging, etc.). Alternatively, if his level of risk would otherwise indicate renter 114 is ineligible for certification in a rental agreement, renter 114 can be required to enable the mobile device for tracking purposes in order to obtain certification for the agreement and he may not be allowed to utilize one or more other features of the mobile device. In one scenario, the mobile device can relay tracking data to rental agency 104 instead of, or in addition to certification entity 102. Warning messages can be transmitted to renter 114 via the mobile device, such as warning renter 114 to slow down.

In one scenario, a rental vehicle can be equipped with a monitoring device that can record vehicle usage, vehicle abuse, and the like. For example, the monitoring device can detect driving habits and abusive behavior. The monitoring data can be relayed to rental agency 104 or certification entity 102 for certification and rental purposes. The data can be employed for other purposes as well; for example, rental agency 104 can employ it when selling the associated vehicle (e.g., to determine a sales price).

Although the present invention has been described mainly in terms of a vehicle rental, this is not to be construed as limiting, as the system and method of the present invention can be applied to any agreement to which an individual is hindered access because of a perception of high-risk. For example, the invention can be applied to real estate rentals, high dollar value transactions, and the like. The invention can be utilized to enable high-risk travelers to travel more freely. For example, an individual from an economically deficient country wishing to visit a wealthier foreign country is often declined a visa because the government of the foreign country deems him a high-risk for illegal immigration (i.e., the individual will remain in the country after the visa expires). If the individual is a participant in the system of the present invention, guarantor 108a/108b can be responsible for ensuring that the individual returns to his country of origin at the appointed time. If the individual does not, guarantor 108a/108b can be held responsible.

These and other aspects of the present invention will become apparent to those skilled in the art by a review of the preceding detailed description. Although a number of salient features of the present invention have been described above, the invention is capable of other embodiments and of being practiced and carried out in various ways that would be apparent to one of ordinary skill in the art after reading the disclosed invention. Therefore, the description should not be considered to be exclusive of these other embodiments. Also, it is to be understood that the phraseology and terminology employed herein are for the purposes of description and should not be regarded as limiting.

What is claimed is:

1. A method for administering a vehicle rental agreement, the method comprising:
a. receiving, at a point of enrollment, qualification data associated with an individual;
b. evaluating the qualification data using one or more risk-analysis criteria;
c. determining whether the individual is an acceptable risk based on the evaluation;
d. certifying the individual as an acceptable risk based upon the determination, wherein certifying the individual qualifies the individual to participate with a reduced hindrance in a vehicle rental agreement for which the individual would otherwise be hindered;
e. issuing to the individual an identifier, wherein the identifier indicates that the individual is certified;
f. receiving, at a point of transaction, a request to participate with a reduced hindrance in the vehicle rental agreement for which the individual would otherwise be hindered, wherein the request includes a presentment of the identifier;
g. approving the request to participate with a reduced hindrance in the vehicle rental agreement using the identifier; and
h. initiating the vehicle rental agreement.

2. The method of claim 1, further comprising receiving qualification data from one or more third party sources.

3. The method of claim 1, wherein qualification data includes one or more of the following: length of time since driver's license issuance, driving history data, criminal record data, police record data, vehicle ownership history data, vehicle usage history data, driver's education course data, education data, insurance data, business reference data, personal reference data, employment data, financial data, age data, lifestyle data, biometric data, government record data, military data, and medical data.

4. The method of claim 1, further comprising receiving qualification data from a guarantor for the individual.

5. The method of claim 4, wherein the guarantor is one or more of a relative of the individual, a guardian of the individual, or an organization with which the individual is associated.

6. The method of claim 4, wherein the guarantor is financially responsible for a cost incurred due to damage of a vehicle during the individual's use of the vehicle rented per the vehicle rental agreement.

7. The method of claim 4, further comprising enabling the guarantor to allow or deny one or more vehicle rental agreements.

8. The method of claim 7, wherein the enabling transpires prior to the receipt of the request to participate in the vehicle rental agreement.

9. The method of claim 7, wherein the enabling transpires after the receipt of the request to participate in the vehicle rental agreement.

10. The method of claim 1, wherein the individual would otherwise be hindered to participate in the vehicle rental agreement due to the age of the individual.

11. The method of claim 1, wherein the hindrance is a restriction from an otherwise available option in the vehicle rental agreement.

12. The method of claim 1, wherein the hindrance is a surcharge for participation in the vehicle rental agreement.

13. A method for administering a rental agreement, the method comprising:
a. receiving, at a point of transaction, a request to participate in a rental agreement, wherein an initial qualification of the individual subjects the individual to a hindrance on the rental agreement;
b. submitting a request to an evaluation processor for certification of the individual;
c. receiving from the evaluation processor an indication of certification of the individual for the rental agreement; and
d. initiating, based upon the received indication of certification, the rental agreement with a reduction in the hindrance.

14. A vehicle rental agreement guarantee system, the system comprising:
a. a vehicle rental entity, wherein the vehicle rental entity enables the rental of a vehicle per a vehicle rental agreement;
b. a point of enrollment, wherein the point of enrollment enables the acquisition of data associated with an individual; and
c. a guarantee provider entity, wherein the guarantee provider entity agrees to pay a monetary value to the vehicle rental entity for a cost incurred due to damage of a vehicle during a use by the individual of the vehicle rented per the vehicle rental agreement, the guarantee provider entity comprising:
i. a database, wherein the database stores received data associated with the individual;
ii. a certification mechanism, wherein the certification mechanism certifies the individual as an acceptable risk to participate with a reduced hindrance in the vehicle rental agreement for which the individual would otherwise be hindered, the certifying being based upon an evaluation of the received data associated with the individual; and
iii. a guarantee enablement mechanism, wherein the guarantee enablement mechanism enables the delivery of a monetary value to the vehicle rental entity for a cost incurred due to damage of the vehicle during use by the individual per the vehicle rental agreement, wherein the vehicle rental agreement is initiated based upon the certification of the individual by the guarantee provider entity.

15. The system of claim 14, wherein the guarantee provider entity further comprises an identifier issuance mechanism, wherein the identifier issuance mechanism issues an identifier that indicates the individual is certified as an acceptable risk to participate with a reduced hindrance in the vehicle rental agreement for which the individual would otherwise be hindered.

16. The system of claim 14, wherein the system further comprises a guarantor entity, wherein the guarantor entity provides a monetary value to the guarantee provider entity for a cost incurred due to use of the vehicle by the individual per the vehicle rental agreement.

17. The method of claim 16, wherein the guarantor entity is one or more of a relative of the individual, a guardian of the individual, or an organization with which the individual is associated.

18. The system of claim 14, wherein the system further comprises a insurance provider entity, wherein the insurance provider entity provides a monetary value to one of the vehicle rental entity or the guarantee provider entity for a cost incurred due to use of the vehicle by the individual per the vehicle rental agreement.

19. A method for guaranteeing a vehicle rental agreement, the method comprising:
a. receiving, at a point of enrollment, data associated with an individual;
b. transmitting the received data associated with the individual to a guarantee provider;
c. generating, at the guarantee provider, a risk score, wherein the risk score is based upon the received data associated with the individual;
d. if the risk score meets a certification threshold, certifying the individual as an acceptable risk to participate with a reduced hindrance in a vehicle rental agreement for which the individual would otherwise be hindered;
e. issuing an identifier to the individual, wherein the identifier indicates the individual is certified as an acceptable risk to participate with a reduced hindrance in the vehicle rental agreement for which the individual would otherwise be hindered;
f. receiving, by a vehicle rental entity, a request from the individual to participate with a reduced hindrance in the vehicle rental agreement for which the individual would otherwise be hindered, wherein the request includes the presentment of the identifier;
g. transmitting a query based on the request to the guarantee provider;
h. confirming, at the guarantee provider, that the individual is eligible to participate with a reduced hindrance in the vehicle rental agreement associated with the request, wherein confirming initiates a guarantee agreement between the vehicle rental entity and the guarantee provider, wherein the guarantee agreement stipulates that the guarantee provider is responsible for a cost incurred due to damage to a use of a vehicle by the individual per the vehicle rental agreement; and
i. initiating the vehicle rental agreement.

20. The method of claim 18, wherein the data associated with the individual includes data associated with a guarantor for the individual.

21. The method of claim 20, wherein the data associated with a guarantor for the individual includes a consent by the guarantor to pay a monetary value to the guarantee provider for a cost incurred due to use of a vehicle by the individual per the vehicle rental agreement.

22. A vehicle rental method, comprising:
a. first receiving, by a vehicle rental entity, a request to rent a vehicle, wherein an age of an individual desiring to rent said vehicle subjects said individual to a vehicle rental restriction in accordance with an age-related policy implemented by said vehicle rental entity;
b. second receiving, by said vehicle rental entity, certification information; and
c. approving, by said vehicle rental entity, said request from said individual to rent said vehicle, said approval being based on a change of said vehicle rental restriction upon a certification of said individual by a certification entity, said certification being produced in response to a certification request that includes said received certification information.

23. The method of claim 21, wherein said certification information includes a certification number assigned to said individual.

24. The method of claim 21, wherein said certification information is a driver's license number.

25. The method of claim 21, wherein said certification information includes an identifier of said certification entity.

26. The method of claim 21, wherein said second receiving comprises receiving a payment token issued in a name of said individual.

27. The method of claim 26, wherein said approving comprises authorizing a charge on said payment token.

28. The method of claim 21, wherein said approving comprises verifying said certification information with said certification entity.

29. The method of claim 21, wherein said certification entity is said vehicle rental entity.

30. A vehicle rental method that enables an individual to rent a vehicle notwithstanding an age-related restriction applicable to the individual, comprising:
a. examining qualification data for the individual, said qualification data including a level of coverage in an automobile insurance policy maintained by the individual;
b. certifying the individual if said examination approves a level of risk indicated by said qualification data;
c. issuing certification information to the individual for subsequent presentation to a vehicle rental entity, wherein said issued certification information enables said vehicle rental entity to change an applicability of the age-related restriction; and
d. periodically recertifiying said individual through a reexamination of at least part of said qualification data, said recertification enabling a certification entity to ensure that said issued certification information remains valid.

31. The method of claim 30, wherein said issuing comprises issuing a certification code.

32. The method of claim 30, wherein said issuing comprises issuing a payment token to the individual.

33. The method of claim 30, wherein said recertifying comprises reexamining a level of coverage of said automobile insurance policy.

34. The method of claim 30, wherein said recertifying comprises reexamining a driving record or accident history.

35. The method of claim 30, wherein said recertifying comprises reexamining a criminal record of said individual.

36. The method of claim 30, wherein said certification entity is a guarantee provider entity.

37. A vehicle rental method in a vehicle rental entity, comprising:
a. first receiving a request to rent a vehicle, wherein an age of an individual desiring to rent said vehicle subjects said individual to a vehicle rental restriction in accordance with an age-related policy implemented by the vehicle rental entity;
b. second receiving certification information generated by a certification entity;
c. identifying a risk level based on said received certification information;
d. segmenting vehicle rental options for said individual into a set of allowable options and a set of prohibited options, said segmenting being based on said identified risk level; and
e. offering a vehicle rental to said individual based on said set of allowable options.

38. The method of claim 37, wherein said risk level is based on a risk score generated by said certification entity.

39. The method of claim 37, wherein said vehicle rental options include a type of vehicle.

40. The method of claim 37, wherein said vehicle rental options include one or more of a duration, time frame, or time of day of a vehicle rental.

41. The method of claim 37, wherein said vehicle rental options include a mileage restriction.

42. The method of claim 37, wherein said vehicle rental options include a vehicle tracking mechanism.

43. The method of claim 37, wherein said certification entity is a guarantee provider entity.

44. The method of claim 37, wherein said vehicle rental options include a rental price.

45. A vehicle rental method in a vehicle rental entity, comprising:
a. receiving a request to rent a vehicle, wherein an age of an individual desiring to rent said vehicle subjects said individual to a vehicle rental restriction in accordance with an age-related policy implemented by the vehicle rental entity;
b. receiving, from a certification entity, vehicle rental option information; and
c. offering a vehicle rental to said individual, said offer being based on a set of allowable options that are indicated by said received vehicle rental option information.
